(19) United States
(12) Patent Application Publication
(10) Pub. No.: US 2011/0098871 A1
(43) Pub. Date: Apr. 28, 2011

(54) METHOD AND APPARATUS FOR UPDATING WINDS ALOFT DISPLAY AS AIRCRAFT ALTITUDE CHANGES

(75) Inventors: Brian Buchanan, Overland Park, KS (US); Jerry Watson, Mission, KS (US); Terry Paul, Paola, KS (US)

(73) Assignee: HONEYWELL INTERNATIONAL INC., Morristown, NJ (US)

(21) Appl. No.: 12/606,936

(22) Filed: Oct. 27, 2009

(51) Int. Cl. G06F 19/00; G01C 23/00

(52) U.S. Cl. 701/14; 340/971

(57) ABSTRACT

A method and apparatus are provided for displaying wind magnitudes and directions aloft as the aircraft (202) changes altitude. Wind magnitudes and directions at a plurality of locations (232) at each of a plurality of predefined altitudes, e.g., surface, 3000 feet, 6000 feet, are received (602) and the aircraft (202) altitude is continually determined (604). The wind magnitudes and directions are displayed (606) at the plurality of locations (232) at one of the plurality of altitudes in response to the determined (604) aircraft altitude.

### FIELD OF THE INVENTION

The present invention generally relates to displaying weather conditions to an aircrew and more particularly to providing wind directions and magnitudes at various altitudes.

### BACKGROUND OF THE INVENTION

World wide air traffic is projected to double every ten to fourteen years and the International Civil Aviation Organization (ICAO) forecasts world air travel growth of five percent per annum until the year 2020. Such growth may cause degradation in safety and performance and an increase in an already high workload of the flight crew. One of the negative influences on flight performance has been aircrew access to weather forecasts. The ability of the aircrew to readily access weather data with transparent (understandable) representation on the display can significantly improve situational awareness of the flight crew resulting in increased flight safety and performance.

It is essential for pilots to have accurate data relating to atmospheric values, for example, winds, at the current location and on the intended route of the aircraft. Such data is important for the safety of the aircraft, optimization of flight economy, as well as for ensuring the required time of arrival is satisfied.

Aircraft typically have sensors on-board that provide data relating to many atmospheric data, including wind, temperature, humidity, and atmospheric pressure. Additionally, atmospheric data on the intended route may be provided from ground based systems and other aircraft. However, this data collected on-board and from other sources may not be of strategic value in that the weather changes as the aircraft changes altitude along its route.

Winds aloft information can be displayed to a pilot in multiple ways including wind barbs, stream lines, and some combination including a color intensity representation. Deciphering the wind information causes the pilot to spend heads down time reviewing the graphical image on the screen. Because winds vary at different altitudes, as the plane's altitude varies, the wind speed may also change. This adds workload to the pilot because he must determine the current altitude and compare this altitude with the currently selected winds aloft display altitude.

Accordingly, it is desirable to provide a method, system, and computer program for displaying wind magnitudes and directions aloft as the aircraft changes altitude. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A method and apparatus are provided for displaying wind magnitudes and directions aloft as the aircraft changes altitude. The method of an exemplary embodiment comprises receiving wind magnitudes and directions at a plurality of locations at each of a plurality of predefined altitudes, continually determining the aircraft altitude as it changes altitude, and displaying the wind magnitudes and directions at one of the plurality of locations in response to the determined altitude.

The apparatus of an exemplary embodiment comprises a processor configured to receive wind magnitude and direction for a first plurality of locations at a first predefined altitude and a second plurality of locations at a second predefined altitude, and continually determine the aircraft altitude; and a display configured to display the wind magnitude and direction for the first plurality of locations when the aircraft is within a range defined by a first aircraft altitude, and display the wind magnitude and direction for the second plurality of locations when the aircraft is within a range defined by a second aircraft altitude.

### BRIEF DESCRIPTION OF THE DRAWINGS

The present invention will hereinafter be described in conjunction with the following drawing figures, wherein like numerals denote like elements, and

FIG. 1 is a block diagram of a system that performs the exemplary embodiments of the present invention;

FIG. 2 is a first representative image showing winds aloft in accordance with an exemplary embodiment;

FIG. 3 is a second representative image including a menu in accordance with the exemplary embodiment;

FIG. 4 is a third representative image showing winds aloft in accordance with the exemplary embodiment;

FIG. 5 is a fourth representative image showing winds aloft in accordance with the exemplary embodiment;

FIG. 6 is a flow chart of the steps of an exemplary embodiment; and

FIG. 7 is a flow chart of the steps of another exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding technical field, background, brief summary, or the following detailed description.

A method is disclosed herein of automatically displaying in two dimensions, either on a cockpit display or on a handheld display, the winds at an altitude approximate to an aircraft's altitude as it changes altitude, to assist the flight crew in evaluating the current flight situation, thereby leading to improved economy and safety.

The method described herein uses an altitude source, for example, a GPS system, to provide an accurate altitude setting. The correct winds aloft flight level information received from a data link weather source is automatically shown to the pilot as the aircraft changes altitude. As the aircraft altitude changes, the appropriate winds aloft flight level information is shown to the pilot.

The pilot's workload in deciphering wind information at the current location may be also be decreased. An indication of the current wind speed at the present position is shown in a configurable data window on the display. The data window can show information from multiple wind speed sources, including on-board sensors such as an air data computer, winds aloft from a data link weather source, or wind information calculated by the pilot, and is prioritized in the order given. If the wind source is from the data link weather, the wind speed value is automatically updated to take into account changes in position as well as changes in altitude.

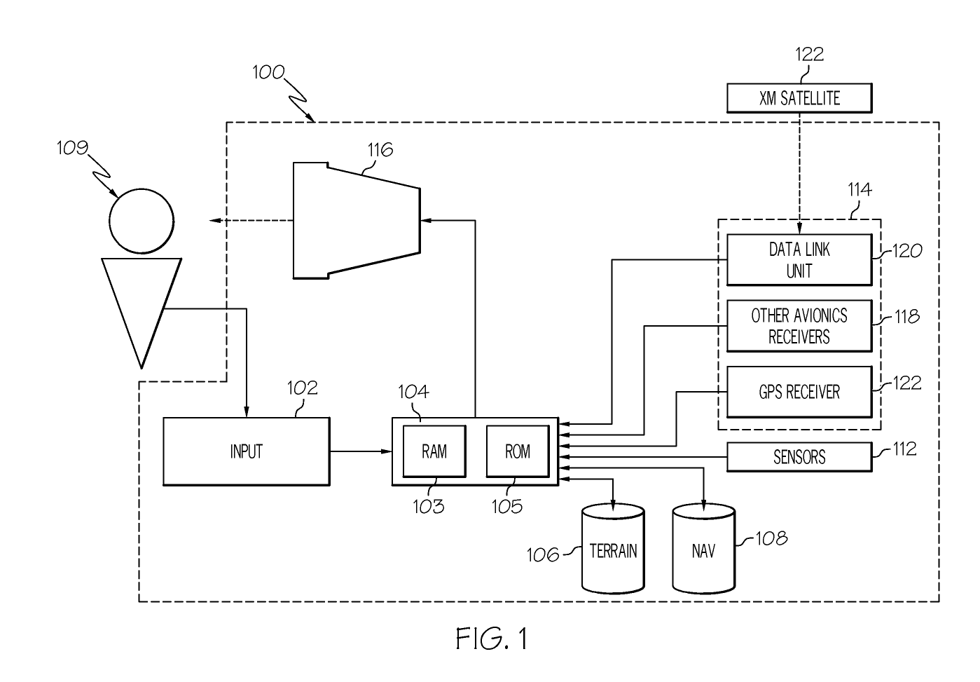

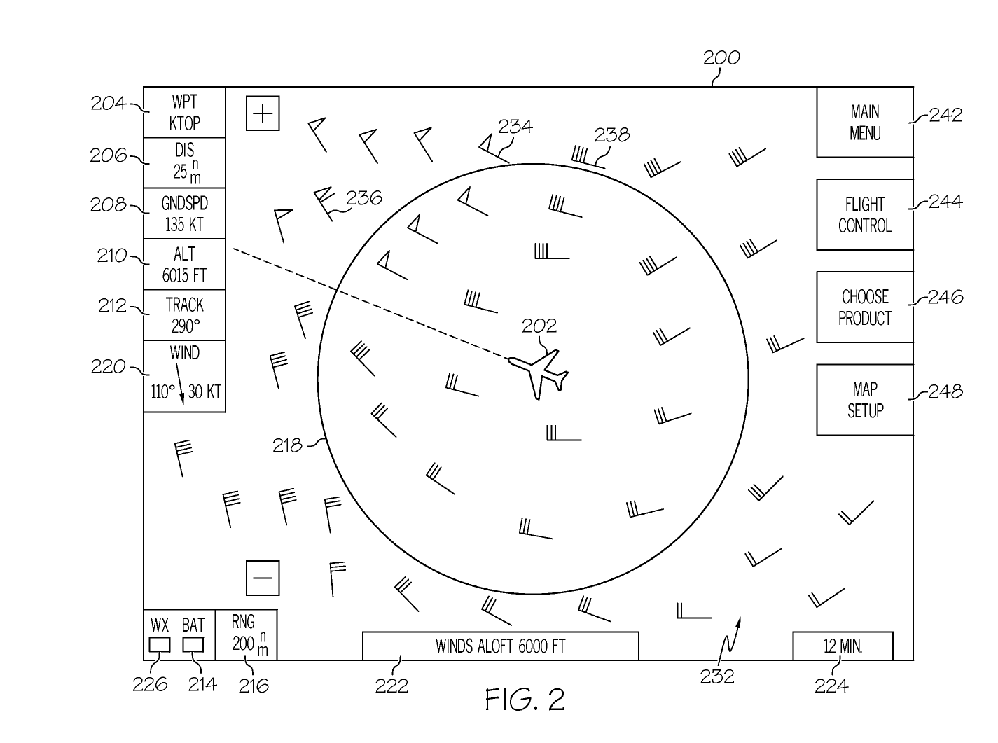

Referring to FIG. 1, an exemplary flight deck display system 100 is depicted and will be described for displaying winds aloft at various altitudes. The system 100 includes a user interface 102, a processor 104, one or more terrain databases 106, one or more navigation databases 108, various optional sensors 112 (for the cockpit display version), various external data sources 114, and a display device 116. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, a cursor control device (CCD) 107, such as a mouse, a trackball, or joystick, and/or a keyboard, one or more buttons, switches, or knobs, and/or a touch screen. The user 109 uses the input 102 to, among other things, select an item on the touch screen, for example (see FIG. 2).

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105, and may include removable flash memory on a Secure Digital (SD) card (not shown). The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

No matter how the processor 104 is specifically implemented, it is in operable communication with the terrain databases 106, the navigation databases 108, and the display device 116, and is coupled to receive various types of inertial data from the various sensors 112, and various other avionics-related data from the external data sources 114. The processor 104 is configured, in response to the inertial data and the avionics-related data, to selectively retrieve terrain data from one or more of the terrain databases 106 and navigation data from one or more of the navigation databases 108, and to supply appropriate display commands to the display device 116. The display device 116, in response to the display commands, selectively renders various types of textual, graphic, and/or iconic information. The preferred manner in which the textual, graphic, and/or iconic information are rendered by the display device 116 will be described in more detail further below. Before doing so, however, a brief description of the databases 106, 108, the sensors 112, and the external data sources 114, at least in the depicted embodiment, will be provided.

The terrain databases 106 include various types of data representative of the terrain over which the aircraft is flying, and the navigation databases 108 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the terrain databases 106 and the navigation databases 108 are, for clarity and convenience, shown as being stored separate from the processor 104, all or portions of either or both of these databases 106, 108 could be loaded into the RAM 103, or integrally formed as part of the processor 104, and/or RAM 103, and/or ROM 105. The terrain databases 106 and navigation databases 108 could also be part of a device or system that is physically separate from the system 100.

The sensors 112 may be implemented using various types of inertial sensors, systems, and or subsystems, now known or developed in the future, for supplying various types of inertial data. The inertial data may also vary, but preferably include data representative of the state of the aircraft such as, for example, aircraft speed, heading, altitude, and attitude. The number and type of external data sources 114 may also vary. For example, the external systems (or subsystems) may include, for example, a terrain avoidance and warning system (TAWS), a traffic and collision avoidance system (TCAS), a runway awareness and advisory system (RAAS), a flight director, and a navigation computer, just to name a few. However, for ease of description and illustration, only an XM datalink unit 120 a global position system (GPS) receiver 122, and other avionics receivers 118 are depicted in FIG. 1, and will now be briefly described.

As is generally known, the XM band radio is a satellite radio service operated by Sirius XM Radio that provides, among other information, aircraft with weather data, including winds aloft through its XM WX satellite weather datacasting service. While an XM service is described, it is understood that any datalink, e.g., an RF link, weather service could be used, transmitted by satellite or ground based transmitters to the aircraft. In the embodiment of FIG. 1, winds aloft data are provided from a satellite 122 to the data link unit 120. Currently, the winds aloft data are updated every hour and are broadcast at 5-15 minute intervals; however, this timing could be changed without impacting the novelty of the exemplary embodiments. Furthermore, the winds aloft data are received by the XM system as an example, and may be obtained from other sources in the alternative.

The GPS receiver 122 is a multi-channel receiver, with each channel tuned to receive one or more of the GPS broadcast signals transmitted by the constellation of GPS satellites (not illustrated) orbiting the earth. Each GPS satellite encircles the earth two times each day, and the orbits are arranged so that at least four satellites are always within line of sight from almost anywhere on the earth. The GPS receiver 122, upon receipt of the GPS broadcast signals from four or more of the GPS satellites, determines the distance between the GPS receiver 122 and the GPS satellites and the position of the GPS satellites. Based on these determinations, the GPS receiver 122, using a technique known as trilateration, determines, for example, aircraft position, groundspeed, and ground track angle. These data may be supplied to the processor 104, which may determine aircraft glide slope deviation therefrom. Preferably, however, the GPS receiver 122 is configured to determine, and supply data representative of, aircraft glide slope deviation to the processor 104.

The display device 116, as noted above, in response to display commands supplied from the processor 104, selectively renders various textual, graphic, and/or iconic information, and thereby supply visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 116 may additionally be implemented as a panel mounted display, a HUD (head-up display) projection, or any one of numerous known technologies. It is additionally noted that the display device 116 may be configured as any one of numerous types of aircraft flight deck displays. For example, it may be configured as a primary flight display, a horizontal situation indicator, or a vertical situation indicator, just to name a few. In the depicted embodiment, however, the display device 116 is configured as a multi-function display.

Referring to FIG. 2, a screen 200 is shown on the display 116 for informing the aircrew of the winds at a specific altitude. The screen 200 may be selected, for example, from a menu on another screen (not shown). The screen 200 includes a subject aircraft 202 and a plurality of informational areas including, for example, a waypoint identifier 204, the distance 206 to from the aircraft 202 to the waypoint (not shown), the ground speed 208, and the altitude 210 of the aircraft 202, the ground track 212 in which the aircraft 202 is flying, a battery (for the handheld embodiment) power remaining indicator 214, and a range indicator 216 showing the distance from the aircraft 202 to the circle 218. The winds shown are for an altitude of 6,000 feet as indicated in the winds aloft indicator 222 and were updated 12 minutes earlier as shown in the time indicator 224. The XM reception quality is shown in the WX indicator 226. The actual wind 220 as determined by the sensors 112 is 30 knots at 110 degrees.

The representation on the screen 200 illustrates a weather data grid of weather information collected from the XM system, including wind magnitudes and direction. The representation is a wind field of symbols 232 indicating the direction of the wind at various locations. The wind indicators provide direction and magnitude. Each line on the indicator represents 10 knots and a flag represents 50 knots. For example, the indicator 234 represents approximately 110 degrees with a 50 knot magnitude, indicator 236 represents approximately 160 degrees with a 60 knot magnitude, and indicator 238 represents approximately 100 degrees with a 40 knot magnitude. Although wind “barbs” are shown in the exemplary embodiment, other methods of representing winds, for example, stream lines, color, and numerals, may be used.

Also appearing on the touch screen 200 is a plurality of selection areas, or buttons. Those buttons shown in FIG. 2 include, but should not be limited to, main menu 242, flight level 244, choose product 246, and map setup 248. Selecting main menu 242 will replace the screen 200 with a main menu (not shown). Selecting choose product 246 will navigate within the software to display another application such as navigation on the display 116. Selecting map setup 248 will provide a menu (not shown) for selecting addition information to be displayed on the screen. For example, the terrain may be displayed on screen 200 in addition to the wind barbs 232.

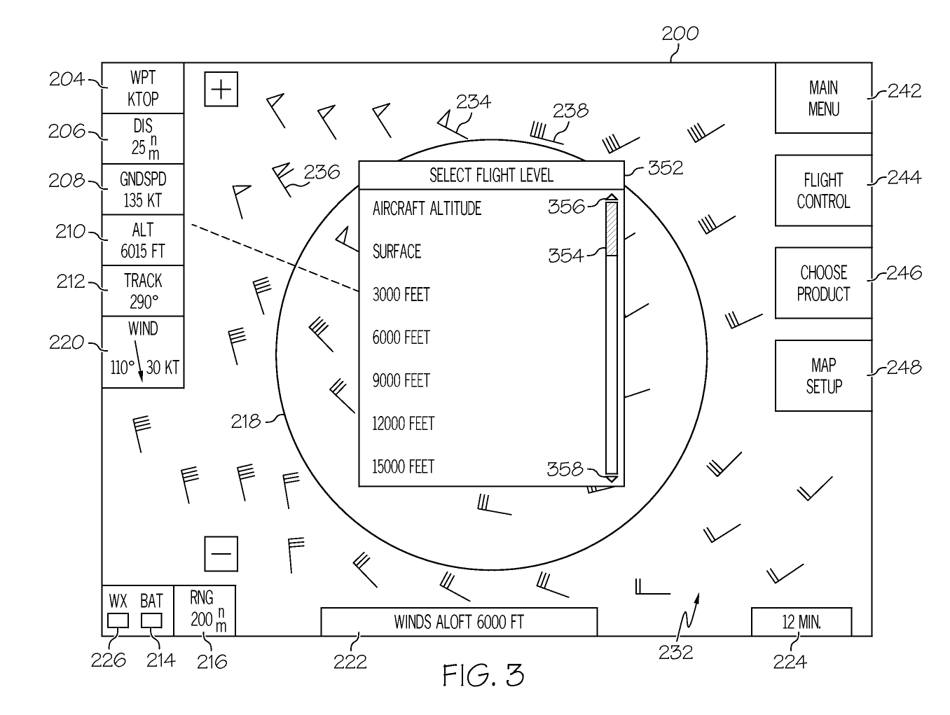

Selection of flight level 244 will display a select flight level menu 352, for example, overlying the data on screen 200 (see FIG. 3). The menu 352 allows for the selection of a plurality of altitudes for which the wind field is provided by the XM system, including the surface and higher altitudes at 3000 feet increments up to a higher flight level such as FL420. While only some of the altitude selections may be shown in the menu 352, known methods of displaying other altitude selections may be provided. The example shown includes the “moving bar” 354 and cursor buttons 356, 358.

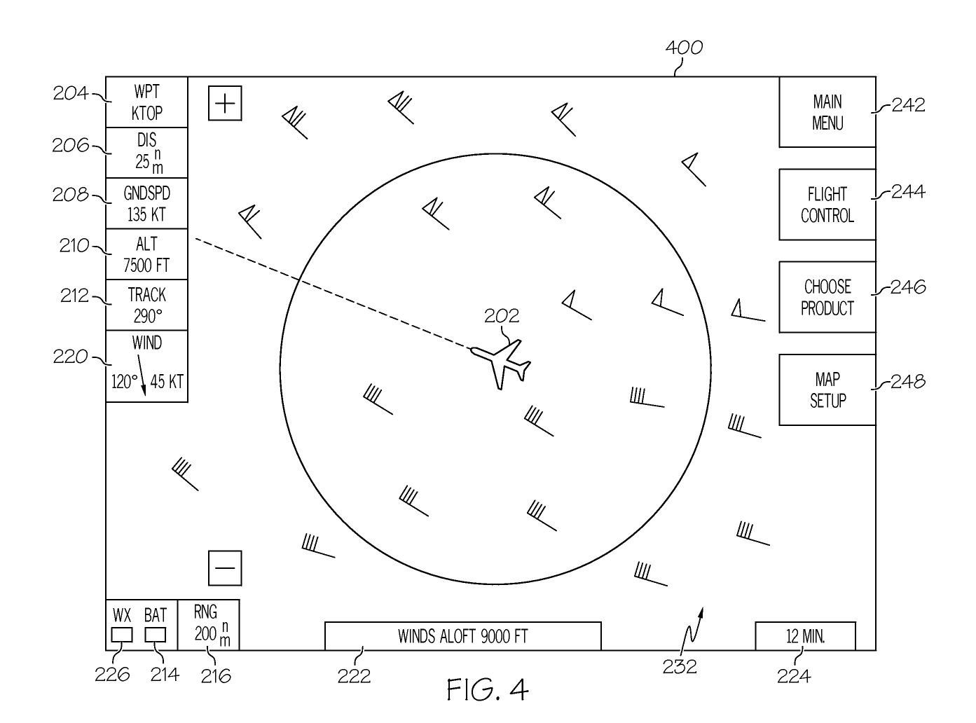

When a pilot desires to see the winds at an altitude other than the current altitude (6000 feet in FIG. 2 and FIG. 3) such as when he is considering or is actually changing altitudes, he could select that altitude from the menu 352. For example, by selecting 9000 FEET from the menu 252 the screen 400 (FIG. 4) would be displayed with the winds aloft field 222 indicating 9000 feet.

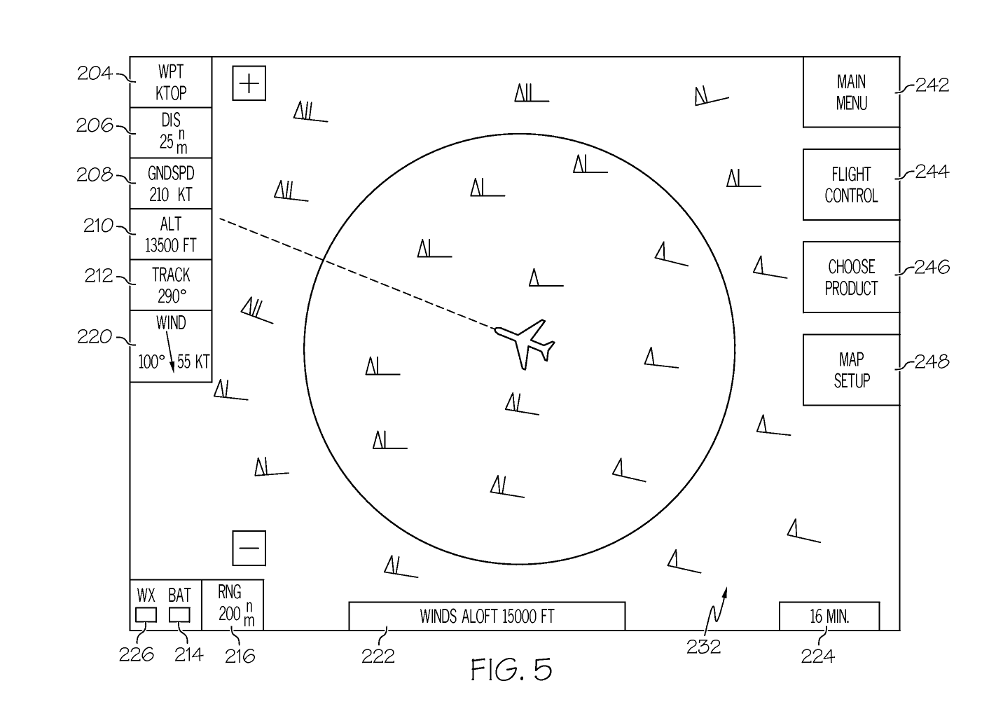

Referring back to the menu 352 of FIG. 3, the pilot also has the option of selecting AIRCRAFT ALTITUDE. When this selection is made, the winds at a particular altitude will be displayed depending on the altitude of the aircraft 202 as determined by the processor 104 in response to data received from the GPS receiver 122. For example, if the aircraft 202 is at about 6,000 feet, the screen 200 of FIG. 2 will be displayed. If the aircraft is climbing to 14,000 feet, the screen 400 of FIG. 4 will be displayed as the plane passes through, for example, 7,500 to 10,500 feet. The altitude 7,500 is halfway between wind data for 6,000 and 9,000 feet and 10,500 is halfway between wind data for 9,000 and 12,000 feet. Likewise, as the plane passes through 10,500 to 13,500, a screen (not shown) displaying winds for 12,000 will be displayed. As the plane passes through 13,500 to reach the altitude of 14,000 feet, a screen 500 (winds aloft for 15,000 feet) of FIG. 5 will be displayed. These transitional altitudes of 7,500 and 10,500 feet are arbitrary. The transition to the next screen could occur at any defined altitude. The winds aloft at 15,000 feet are displayed when the aircraft is at 14,000 feet because those are the winds aloft at the altitude closest to the aircraft altitude. Note that the altitude 210 now is 14,000, the ground speed 208 is 210 knots, the distance 206 to the waypoint KTOP is 13 nautical miles, and the actual wind 220 is 55 knots at 100 degrees.

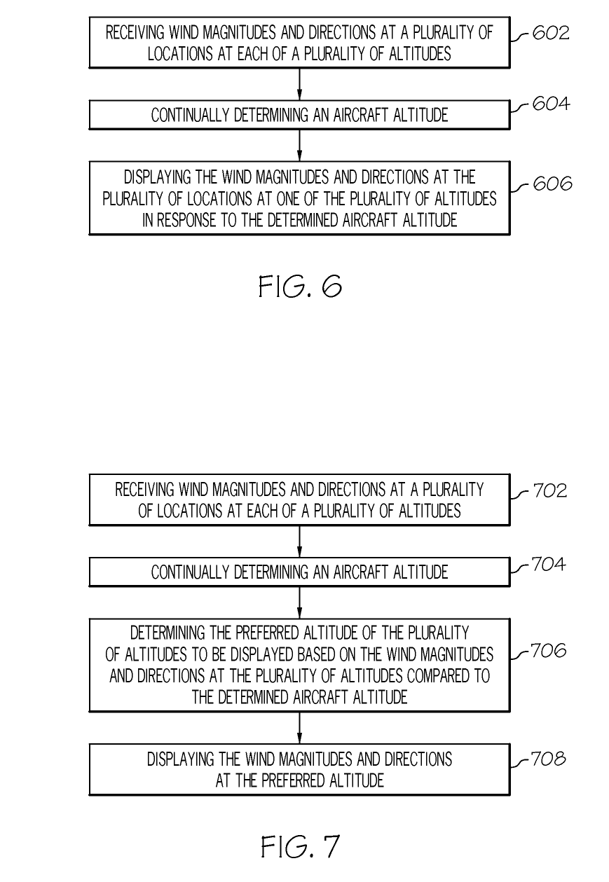

FIG. 6 is a flow chart of the exemplary embodiment described in FIGS. 2-5, and includes the steps of receiving 602 wind magnitudes and directions at a plurality of locations 232 at each of a plurality of altitudes, e.g., surface, 3,000 feet, 6,000 feet, and so forth. The magnitudes typically are expressed in knots/hour and the locations (of the wind barbs 232) are determined by a wind forecast model, such as a RUC wind model provided by the National Weather Service, wherein the wind barbs are equidistantly spaced within a polygon shape that covers a large part of North America including all of the US lower 48 states and part of Canada and Mexico. The aircraft altitude is continually determined 604, including level flight and as it changes altitude (climb or descent). The wind magnitudes and directions at the plurality of locations 232 are displayed 606 at one of the plurality of altitudes in response to the determined 604 aircraft altitude.

Another exemplary embodiment is shown in FIG. 7 wherein wind magnitudes and directions at a plurality of locations 232 are received 702 at each of a plurality of altitudes, e.g., surface, 3,000 feet, 6,000 feet, and so forth. The aircraft altitude is continually determined 704, including level flight and as it changes altitude (climb or descent). A determination 704 is made of the preferred altitude winds to be displayed based on the wind magnitudes and directions at the plurality of altitudes compared to the determined aircraft altitude. The wind magnitudes and directions at the preferred altitude are then displayed 708. The processor 104 may determine, when the aircraft is at 14,000 feet, that it would be preferred to display the winds aloft at 12,000 feet instead of the winds aloft at 15,000 feet. For example, if the tail winds are unusually higher at 12,000 feet than the winds at 15,000 feet, a display of the winds aloft at 12,000 may be preferred.

A method, system, and computer program for displaying wind magnitudes and directions aloft as the aircraft changes altitude has been described. The winds (wind field) for each of a plurality of predetermined altitudes are received from a weather source. The wind field for a particular one of the predetermined altitudes is displayed in response to the altitude of the aircraft. As the altitude of the aircraft changes, the wind field of another predetermined altitude may be displayed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of displaying wind magnitudes and directions to an aircrew, comprising:
receiving wind magnitudes and directions at a plurality of locations at each of a plurality of altitudes;
continually determining the current aircraft altitude; and
displaying the wind magnitudes and directions at the plurality of locations at one of the plurality of altitudes in response to the determined aircraft altitude.

2. The method of claim 1 wherein the determining step comprises determining the aircraft's global positioning satellite coordinates.

3. The method of claim 1 wherein the receiving step comprises receiving from a data link weather source.

4. The method of claim 1 wherein the displaying step comprises displaying the wind magnitudes and directions for an altitude closest to the current aircraft altitude.

5. The method of claim 1 further displaying the wind magnitudes and directions for an altitude determined to be the most efficient within a range of altitudes for the route of flight.

6. The method of claim 1 wherein the displaying step comprises displaying the optimum of the two closest altitudes compared to the current aircraft altitude.

7. The method of claim 6 wherein the displaying step comprises determining the optimum altitude by selecting the altitude with the winds most different from the current aircraft altitude.

8. A method for displaying winds aloft to an aircrew of an aircraft, comprising:
receiving wind magnitude and direction for a first plurality of locations at a first predefined altitude;
receiving wind magnitude and direction for a second plurality of locations at a second predefined altitude;
continually determining the current aircraft altitude;
displaying the wind magnitude and direction for the first plurality of locations when the current aircraft altitude is within a range defined by a first aircraft altitude; and
displaying the wind magnitude and direction for the second plurality of locations when the current aircraft altitude is within a range defined by a second aircraft altitude.

9. The method of claim 8 wherein the determining step comprises determining the aircraft's global positioning satellite coordinates.

10. The method of claim 8 wherein the receiving steps both comprise receiving from a data link weather source.

11. The method of claim 8 wherein the displaying step comprises displaying the wind magnitudes and directions for an altitude closest to the current aircraft altitude.

12. The method of claim 8 further displaying the wind magnitudes and directions for an altitude determined to be the most efficient within a range of altitudes for the route of flight.

13. The method of claim 8 wherein the displaying step comprises displaying the optimum of the two closest altitudes compared to the current aircraft altitude.

14. The method of claim 13 wherein the displaying step comprises determining the optimum altitude by selecting the altitude with the winds most different from the current aircraft altitude.

15. A system for displaying winds at a determined one of a plurality of altitudes to the aircrew of an aircraft, comprising:
a processor configured to
receive wind magnitude and direction for a first plurality of locations at a first predefined altitude and a second plurality of locations at a second predefined altitude;
continually determine the aircraft altitude;
a display configured to
display the wind magnitude and direction for the first plurality of locations when the aircraft is within a range defined by a first aircraft altitude; and
display the wind magnitude and direction for the second plurality of locations when the aircraft is within a range defined by a second aircraft altitude.

16. The system of claim 15 further comprising:
a GPS receiver coupled to the processor and configured to receive signals, wherein the processor determines the aircraft altitude in response to the received signals.

17. The system of claim 15 further comprising:
a data link receiver coupled to the processor and configured to receive wind magnitude and direction at the first and second plurality of locations.

18. The system of claim 15 wherein the processor is further configured to determine the wind magnitude and direction for the current aircraft altitude, and the display is further configured to display a numerical representation of the wind magnitude and direction at the current altitude.
